(19) United States
(12) Patent Application Publication
(10) Pub. No.: US 2017/0310176 A1
(43) Pub. Date: Oct. 26, 2017

(54) ROTOR, METHOD OF MANUFACTURING ROTOR, AND ROTARY ELECTRIC MACHINE INCLUDING ROTOR

(71) Applicant: KYB Corporation, Tokyo (JP)

(72) Inventors: Takayuki KAWAGUCHI, Kanagawa (JP); Yoshiteru KUROKAWA, Kanagawa (JP)

(73) Assignee: KYB Corporation, Tokyo (JP)

(21) Appl. No.: 15/516,988

(22) PCT Filed: Oct. 16, 2015
(86) PCT No.: PCT/JP2015/079246

§ 371 Date: Apr. 5, 2017

(30) Foreign Application Priority Data
Oct. 29, 2014 (JP) 2014-220686

(51) Int. Cl. H02K 1/28; H02K 15/03; H02K 1/27

(52) U.S. Cl. CPC H02K 1/28; H02K 1/278; H02K 15/03

(57) ABSTRACT

A rotor includes a rotor core fixed to a shaft in such a manner that the rotor core is rotatable integrally with the shaft, the rotor core having a plurality of permanent magnets mounted thereon throughout a circumferential direction; and a tubular rotor cover covering an outer circumference of the rotor core. The rotor cover includes an angular portion and a groove portion, the angular portion has a shape of a circular ring and is formed at an axial end of the rotor core, the groove portion is formed in the rotor cover, in a course of formation of the angular portion, as a dent between a circumferentially neighboring pair of the plurality of permanent magnets.

### TECHNICAL FIELD

The present invention relates to a rotor, a method of manufacturing the rotor, and a rotary electric machine including the rotor.

### BACKGROUND ART

JP 1999-299149A discloses a rotor used in a rotary electric machine. This rotor includes a yoke and covers. Magnets are mounted on the outer circumference of the yoke. The outer circumferential surfaces of the magnets are covered with the covers. Cutouts are formed in the circumferential ends of each magnet. Recesses are formed in an open edge of each cover. The recesses of the covers are each locked into opposing cutouts of neighboring magnets, thereby restricting axial and circumferential movements of the covers.

### SUMMARY OF INVENTION

With the foregoing conventional technique, in order to circumferentially fix the covers with respect to the yoke, that is to say, in order to stop the rotation of the covers, the magnets and the covers need to be processed before covering the outer circumferences of the magnets with the covers. This increases the number of manufacturing processes.

The present invention aims to suppress an increase in the number of processes while stopping the rotation of a rotor cover.

According to one aspect of the present invention, a rotor includes a rotor core fixed to a rotation axis in such a manner that the rotor core is rotatable integrally with the rotation axis, the rotor core having a plurality of permanent magnets mounted thereon throughout a circumferential direction; and a tubular rotor cover covering an outer circumference of the rotor core. The rotor cover includes an angular portion and a groove portion, the angular portion has a shape of a circular ring and is formed at an axial end of the rotor core, the groove portion being formed in the rotor cover, in a course of formation of the angular portion, as a dent between a circumferentially neighboring pair of the plurality of permanent magnets.

### BRIEF DESCRIPTION OF DRAWINGS

FIG. 1 is a cross-sectional view showing a rotary electric machine including a rotor according to an embodiment of the present invention.

FIG. 2 is a perspective view showing the rotor according to the embodiment of the present invention.

FIG. 3 is a cross-sectional view showing a cross-section of the rotor taken along a plane including a rotation axis of a shaft.

FIG. 4 illustrates rotor manufacturing processes.

FIG. 5 illustrates the rotor manufacturing processes.

FIG. 6 illustrates the rotor manufacturing processes.

FIG. 7A illustrates the rotor manufacturing processes.

FIG. 7B is a cross-sectional view showing a cross-section taken along plane 7B in FIG. 7A.

FIG. 8 illustrates the rotor manufacturing processes.

FIG. 9 illustrates the rotor manufacturing processes.

FIG. 10 illustrates the rotor manufacturing processes.

FIG. 11 illustrates the rotor manufacturing processes.

FIG. 12 illustrates the rotor manufacturing processes.

FIG. 13 illustrates the rotor manufacturing processes.

FIG. 14 illustrates the rotor manufacturing processes.

FIG. 15 illustrates the rotor manufacturing processes.

FIG. 16 illustrates the rotor manufacturing processes.

FIG. 17 is an enlarged view of section A in FIG. 10 after removal of an external die, depicting a case in which groove portions are formed to extend only in a radial direction.

### DESCRIPTION OF EMBODIMENTS

The following describes an embodiment of the present invention with reference to the attached drawings.

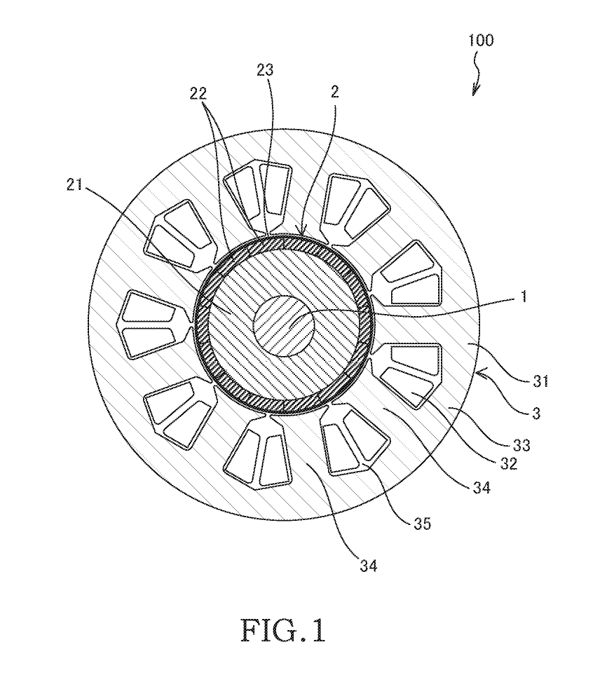

FIG. 1 is a cross-sectional view showing a cross-section of a rotary electric machine 100 including a rotor 2 according to the present embodiment, taken along a direction perpendicular to a rotation axis.

The rotary electric machine 100 functions as at least one of a motor and an electric generator. The rotary electric machine 100 includes a rotatable shaft 1 serving as the rotation axis, the rotor 2 fixed integrally to the shaft 1, and a stator 3 opposing an outer circumference of the rotor 2 via a predetermined void.

The rotor 2 includes a rotor core 21, permanent magnets 22, and a rotor cover 23. The rotor core 21 is fixed to an outer circumference of the shaft 1, and thus rotates together with the shaft 1. The permanent magnets 22 are arranged at an equal interval on an outer circumferential surface of the rotor core 21 throughout a circumferential direction. The rotor cover 23 houses the rotor core 21 on which the permanent magnets 22 have been mounted.

The stator 3 includes a stator core 31 having a shape of a circular ring, and windings 32. The stator core 31 is disposed to encircle the rotor 2 in such a manner that a predetermined void is present between the rotor 2 and the stator core 31. The windings 32 are wound and mounted on the stator core 31.

The stator core 31 includes a ring-shaped yoke 33, a plurality of teeth 34, and slots 35. The teeth 34 project radially inward from the yoke 33, and are arranged at a predetermined interval in the circumferential direction. Each slot 35 is defined by neighboring teeth 34 so as to be located at the inner circumferential side of the yoke 33.

The windings 32 are wound around the teeth 34 of the stator core 31. Accordingly, a coil is formed on each tooth 34. The ends of the windings 32 are connected to an electrode (not shown) of the stator 3. When electric power is supplied to the coils via the electrode, the stator core 31 is magnetized, and the interaction between the stator core 31 and the permanent magnets 22 of the rotor 2 causes the rotor 2 to rotate with the shaft 1 serving as the axis.

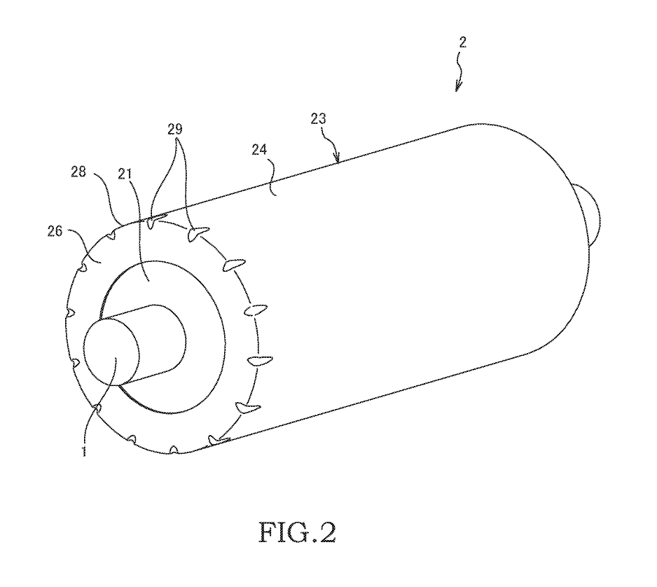

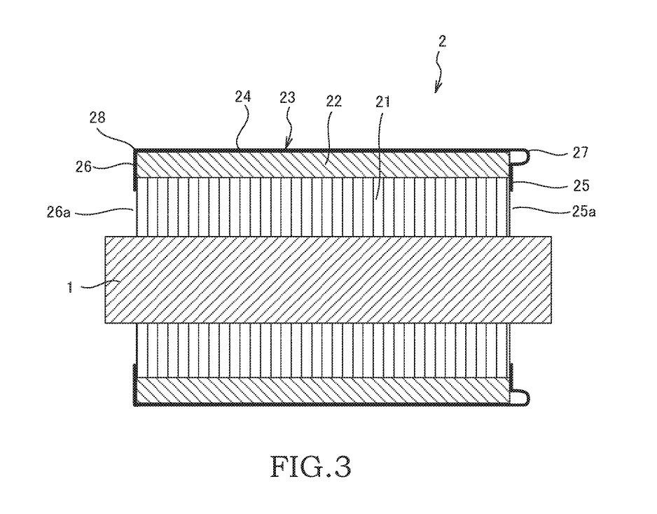

FIG. 2 is a perspective view showing the rotor 2 according to the present embodiment. FIG. 3 is a cross-sectional view showing a cross-section of the rotor 2 taken along a plane including the rotation axis of the shaft 1.

The rotor cover 23 is made of non-magnetic stainless steel, and formed into a shape of a tube with a bottom so as to house the rotor core 21 on which the permanent magnets 22 have been mounted. The rotor cover 23 includes a tubular portion 24, a bottom portion 25, and an upper surface portion 26. The tubular portion 24 covers an outer circumference of the rotor core 21. The bottom portion 25 comes into contact with an end of the rotor core 21 at one axial side (the right side in FIG. 3). The upper surface portion 26 comes into contact with an end of the rotor core 21 at the other axial side (the left side in FIG. 3).

The bottom portion 25 is formed into a shape of a circular ring, and has a central hole 25a and a surface that is perpendicular to an axial direction. The hole 25a is larger in diameter than the shaft 1. An end of the tubular portion 24 and an outer circumferential end of the bottom portion 25 are connected via a projection 27 that axially projects from the end of the tubular portion 24.

The upper surface portion 26 is formed into a shape of a circular ring, and has a central hole 26a and a surface that is perpendicular to the axial direction. The hole 26a is larger in diameter than the shaft 1. The upper surface portion 26 is formed by bending an end of the tubular portion 24 at the other axial side radially inward. An angular portion 28 having a shape of a circular ring is formed between the tubular portion 24 and the upper surface portion 26. Groove portions 29 are formed in the angular portion 28. Each groove portion 29 is formed as a dent between circumferentially neighboring permanent magnets 22. The groove portions 29 are formed at the time of forming the angular portion 28, and function as detents that stop the rotation of the rotor cover 23.

The holes of the bottom portion and the upper surface portion are smaller in diameter than the rotor core. The bottom portion and the upper surface portion extend to cover and hide the side surfaces of the permanent magnets.

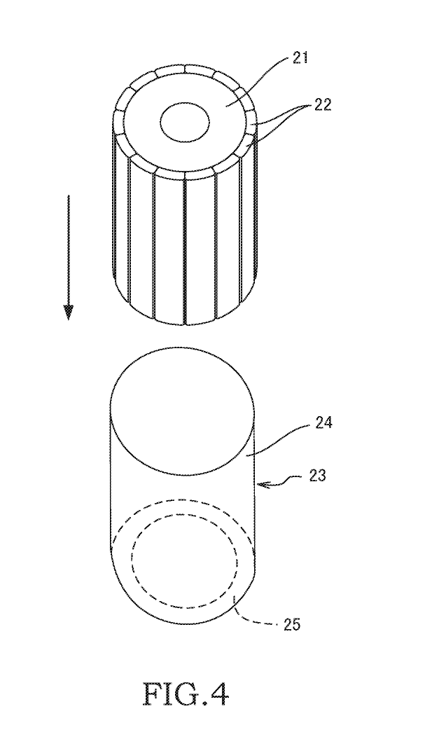

A description is now given of a method of manufacturing the rotor 2 with reference to FIGS. 4 to 16.

First, the plurality of permanent magnets 22 are mounted on the outer circumferential surface of the rotor core 21. The permanent magnets 22 are mounted using an adhesive or the like so as to be arranged at an equal interval throughout the circumferential direction.

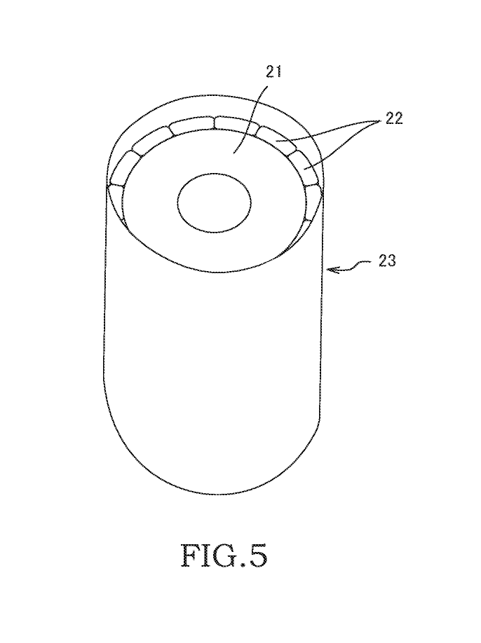

Next, as shown in FIG. 4, the rotor core 21 on which the permanent magnets 22 have been mounted is inserted through an open end of the rotor cover 23 having the preformed bottom portion 25. Consequently, the rotor core 21 is housed in the rotor cover 23. At this stage, the upper surface portion 26 is not formed yet. Therefore, as shown in FIG. 5, once the rotor core 21 has been inserted to the point where it is in contact with the bottom portion 25 of the rotor cover 23, the open end of the rotor cover 23 is positioned above the upper end of the rotor core 21.

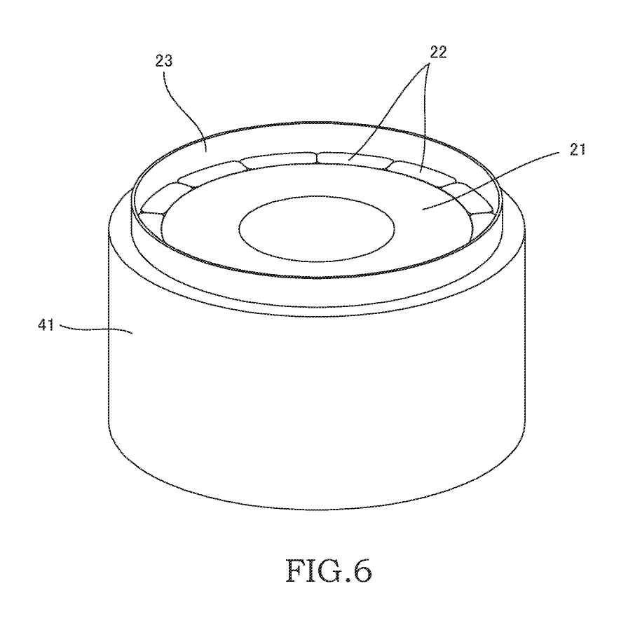

Next, as shown in FIG. 6, an external die 41 serving as a restricting member is placed so as to surround an open end side of an outer circumference of the tubular portion 24 of the rotor cover 23. The external die 41 is a tubular member whose inner diameter is substantially equal to the outer diameter of the tubular portion 24 of the rotor cover 23. The external die 41 restricts radially outward bulging of the tubular portion 24 of the rotor cover 23 when the rotor cover 23 is pressed radially inward as will be described later. The height of the external die 41 is substantially the same as the height of the rotor core 21.

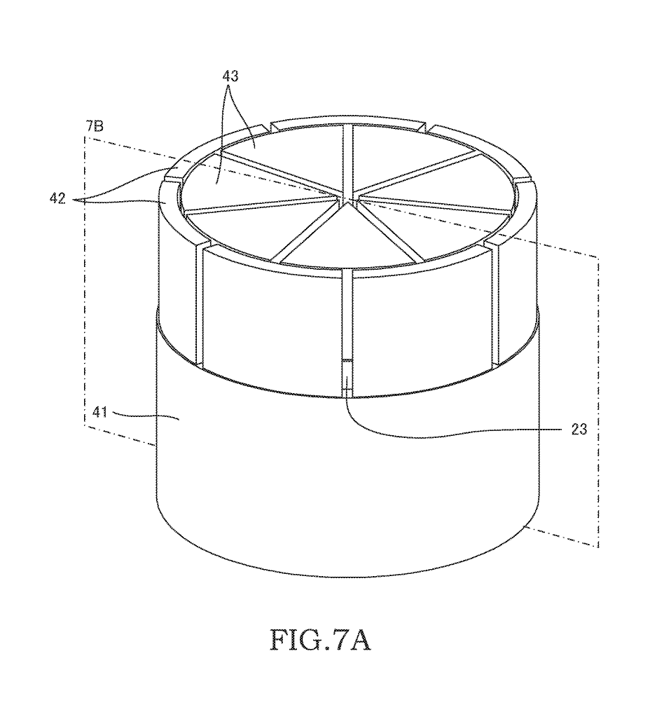

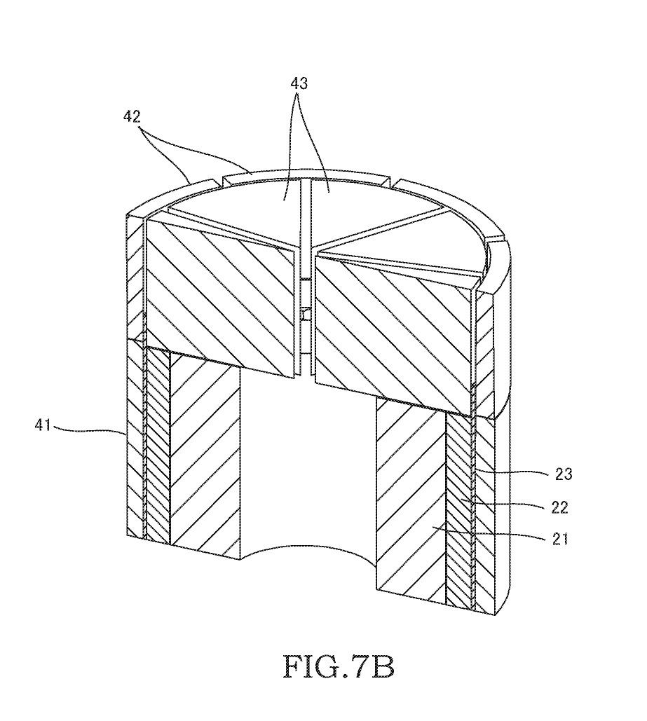

Next, as shown in FIG. 7A, a plurality of external collet segments 42, which are circumferentially separated from one another and serve as pressing members, are placed atop the external die 41. The external collet segments 42 are arranged to be in contact with an outer circumferential surface of the open end of the rotor cover 23 in such a manner that predetermined circumferential gaps are present between the external collet segments 42.

Furthermore, a plurality of internal collet segments 43, which are circumferentially separated from one another and serve as holding members, are placed atop the rotor core 21 at the inner circumferential side of the rotor cover 23. The internal collet segments 43 are arranged to be in contact with an inner circumferential surface of the open end of the rotor cover 23 in such a manner that predetermined circumferential gaps are present between the internal collet segments 43.

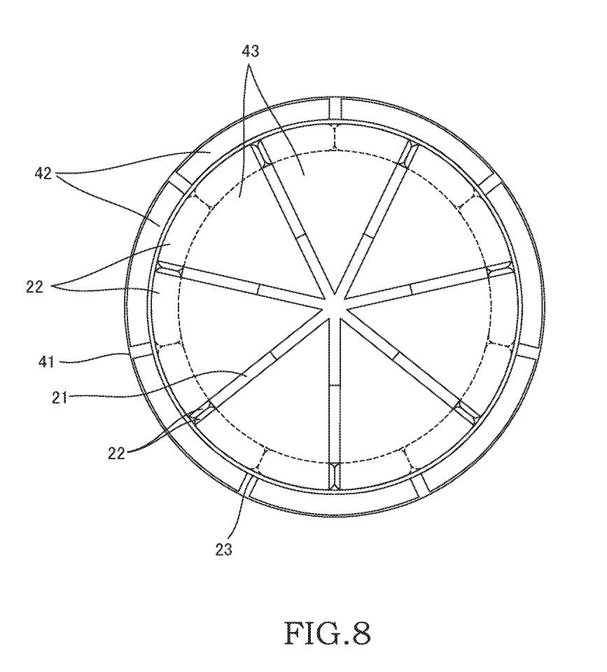

The number of the separated external collet segments 42 and the number of the separated internal collet segments 43 are each half of the number of the permanent magnets 22. That is to say, one external collet segment 42 and one internal collet segment 43 are each equivalent in size to two permanent magnets 22. As shown in FIG. 8, the gaps between the external collet segments 42 and the gaps between the internal collet segments 43 are each positioned between circumferentially neighboring permanent magnets 22 of the rotor core 21. Furthermore, the external collet segments 42 and the internal collet segments 43 are arranged in such a manner that the gaps between the former are circumferentially misaligned with respect to the gaps between the latter by one permanent magnet 22.

Next, while the internal collet segments 43 are pressed radially outward, the external collet segments 42 are pressed radially inward. At this time, pressing forces of the external collet segments 42 exceed pressing forces of the internal collet segments 43. Consequently, the open end of the rotor cover 23 is pushed radially inward by the external collet segments 42 while its inner circumference is held by the internal collet segments 43. At this time, a portion of the rotor cover 23 that is pushed radially inward may be simply pulled, or may be stretched as in a drawing process, radially inward by the external collet segments 42 and the internal collet segments 43. Whether the portion is pulled or stretched is adjusted depending on the relationship between the pressing forces of the external collet segments 42 and the internal collet segments 43. Wrinkles may be or may not be formed in the portion of the rotor cover 23 that is pushed radially inward in pulling or stretching the portion.

The external collet segments 42 exert the pressing forces not only radially inward, but also axially downward. This can reduce springback upon completion of the upper surface portion 26. Axially downward pressing by the external collet segments 42 is attributed to the weight of the external collet segments 42 or application of an external stress, and is performed after the external collet segments 42 have sufficiently moved radially inward.

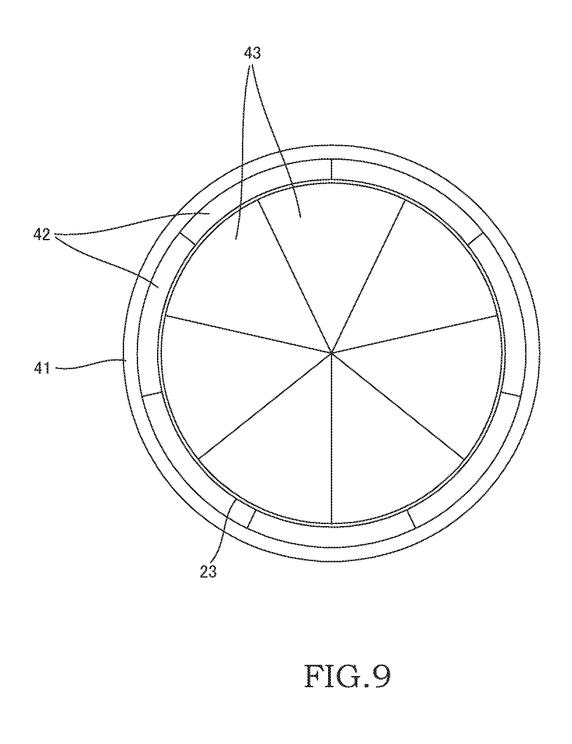

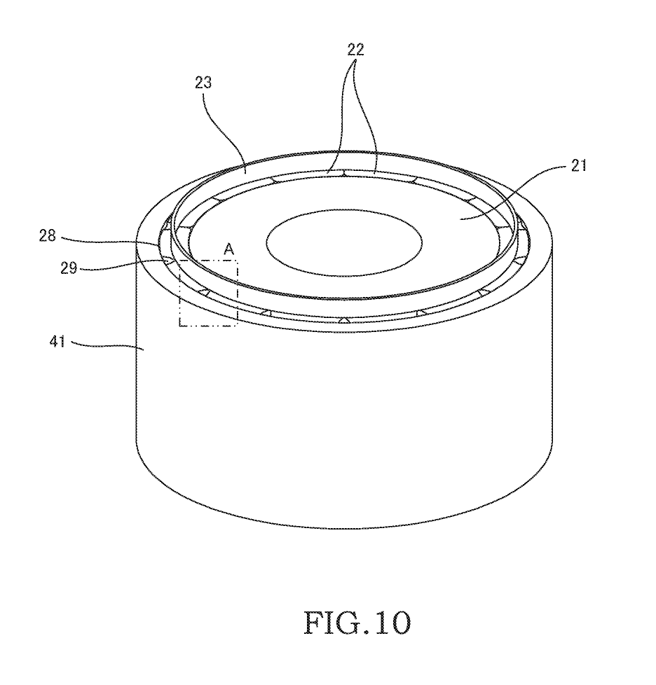

As shown in FIG. 9, the open end of the rotor cover 23 is pushed radially inward so that the gaps between the external collet segments 42 and the gaps between the internal collet segments 43 decrease. Consequently, as shown in FIG. 10, removal of the external collet segments 42 and the internal collet segments 43 reveals that the open end of the rotor cover 23 has been bent and is positioned more radially inward than the tubular portion 24 is, and that the angular portion 28 having a shape of a circular ring has been formed. Furthermore, in the angular portion 28, portions of the open end of the rotor cover 23 each enter a gap between neighboring permanent magnets 22, thereby forming the groove portions 29. Each groove portion 29 is formed at a boundary between neighboring permanent magnets 22.

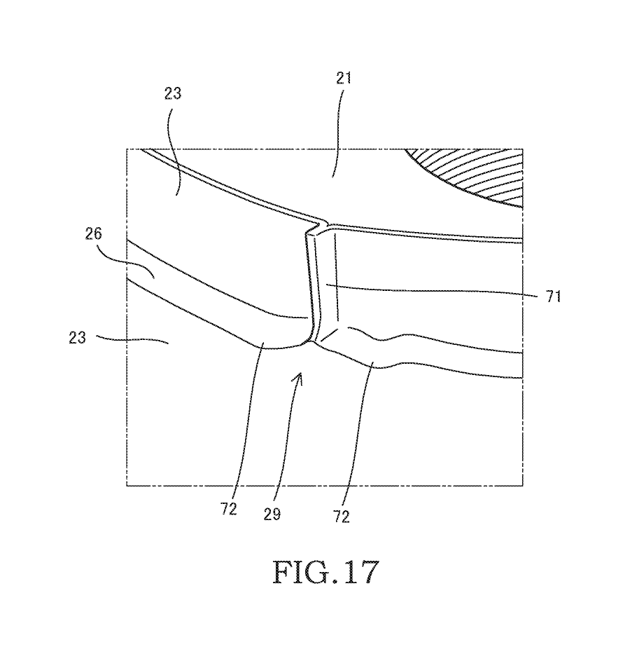

Note that the groove portions 29 may be formed to extend from the open end of the rotor cover 23, which has been bent and is positioned more radially inward than the tubular portion 24 is, in the axial and radial directions as shown in FIGS. 2 and 10, or only in the radial direction. FIG. 17 is an enlarged view of section A in FIG. 10 after removal of the external die 41, depicting a case in which the groove portions 29 are formed to extend only in the radial direction. In this case, wrinkle portions 71 are formed in the upper surface portion 26, and wall portions that remain as residues at the time of formation of the wrinkle portions 71 dent as they exert forces to escape in the axial direction. Consequently, the groove portions 29 are formed. As shown in FIG. 17, the wrinkle portions 71 are formed in the groove portions 29. Each wrinkle portion 71 projects from a boundary between two grooves 72 formed at both edges of the corresponding groove portion 29.

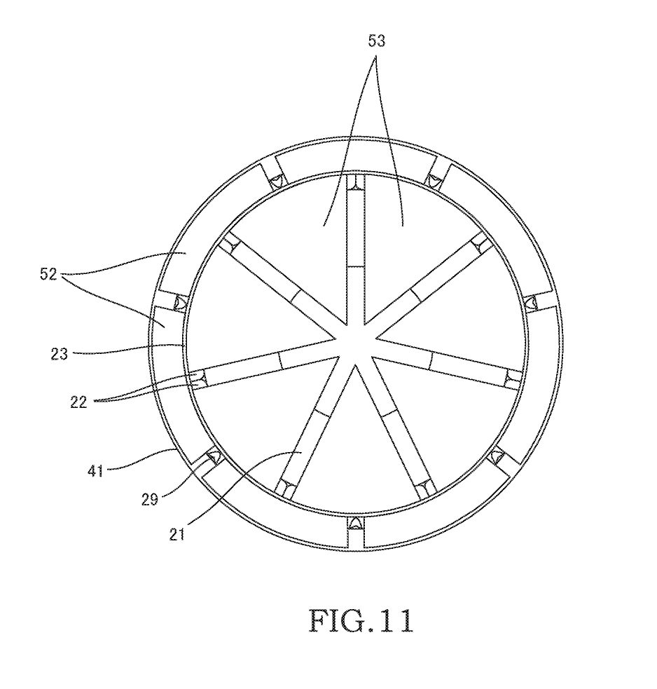

Next, as shown in FIG. 11, external collet segments 52 are placed at the outer circumferential side of the open end of the rotor cover 23, and internal collet segments 53 are placed at the inner circumferential side of the open end of the rotor cover 23. During the transition from the state of FIG. 8 to the state of FIG. 9, the open end of the rotor cover 23 is reduced in diameter by being bent radially inward by the external collet segments 42 and the internal collet segments 43. Therefore, the external collet segments 52 are larger in radial thickness than the external collet segments 42 shown in FIG. 8, and the internal collet segments 53 are smaller in radial dimension than the internal collet segments 43 shown in FIG. 8.

The external collet segments 52 and the internal collet segments 53 are respectively separated, and the number of the external collet segments 52 and the number of the internal collet segments 53 are each half of the number of the permanent magnets 22. That is to say, one external collet segment 52 and one internal collet segment 53 are each equivalent in size to two permanent magnets 22. As shown in FIG. 11, gaps between the external collet segments 52 and gaps between the internal collet segments 53 are each positioned between circumferentially neighboring permanent magnets 22 of the rotor core 21. Furthermore, the external collet segments 52 and the internal collet segments 53 are arranged in such a manner that the gaps between the former are circumferentially misaligned with respect to the gaps between the latter by one permanent magnet 22. The external collet segments 52 are also arranged in such a manner that the gaps between themselves are circumferentially misaligned with respect to the gaps between the external collet segments 42 shown in FIG. 8. The internal collet segments 53 are also arranged in such a manner that the gaps between themselves are circumferentially misaligned with respect to the gaps between the internal collet segments 43 shown in FIG. 8.

Next, while the internal collet segments 53 are pressed radially outward, the external collet segments 52 are pressed radially inward. At this time, pressing forces of the external collet segments 52 exceed pressing forces of the internal collet segments 53. Consequently, the open end of the rotor cover 23 is pushed radially inward by the external collet segments 52 while its inner circumference is held by the internal collet segments 53. At this time, a portion of the rotor cover 23 that is pushed radially inward may be simply pulled, or may be stretched as in a drawing process, radially inward by the external collet segments 52 and the internal collet segments 53. Whether the portion is pulled or stretched is adjusted depending on the relationship between the pressing forces of the external collet segments 52 and the internal collet segments 53. Wrinkles may be or may not be formed in the portion of the rotor cover 23 that is pushed radially inward in pulling or stretching the portion.

The external collet segments 52 exert the pressing forces not only radially inward, but also axially downward. This can reduce springback upon completion of the upper surface portion 26. Axially downward pressing by the external collet segments 52 is attributed to the weight of the external collet segments 52 or application of an external stress, and takes place after the external collet segments 52 have sufficiently moved radially inward.

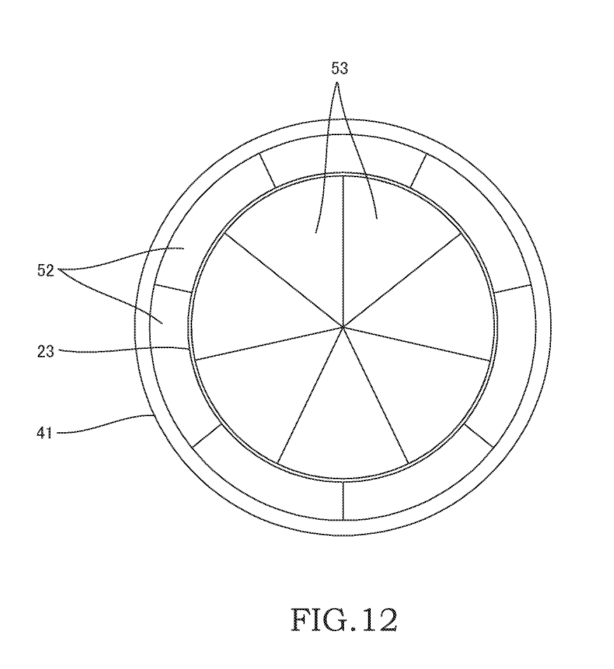

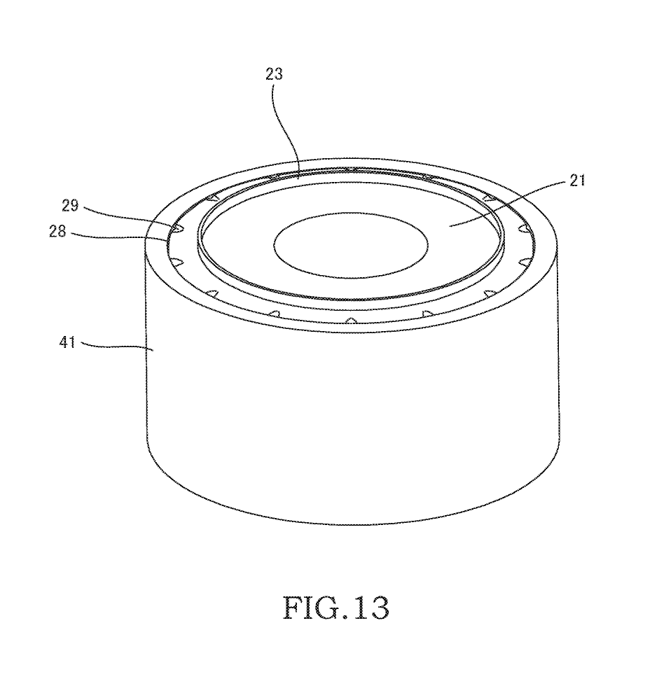

As shown in FIG. 12, the open end of the rotor cover 23 is pushed radially inward so that the gaps between the external collet segments 52 and the gaps between the internal collet segments 53 decrease. Consequently, as shown in FIG. 13, removal of the external collet segments 52 and the internal collet segments 53 reveals that the open end of the rotor cover 23 has been further pushed radially inward relative to the tubular portion 24. At this time, in the angular portion 28, portions of the open end of the rotor cover 23 each enter a gap between neighboring permanent magnets 22, thereby forming the groove portions 29. Each groove portion 29 is formed at a boundary between neighboring permanent magnets 22.

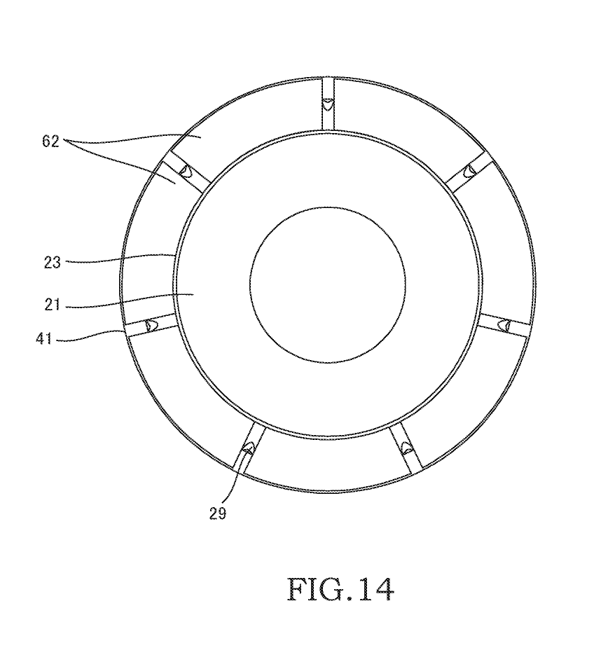

Next, as shown in FIG. 14, external collet segments 62 are placed at the outer circumferential side of the open end of the rotor cover 23. During the transition from the state of FIG. 11 to the state of FIG. 12, the open end of the rotor cover 23 is reduced in diameter by being pushed radially inward by the external collet segments 52 and the internal collet segments 53. Therefore, the external collet segments 62 are larger in radial thickness than the external collet segments 52 shown in FIG. 11.

The external collet segments 62 are separated from one another, and the number of the external collet segments 62 is half of the number of the permanent magnets 22. That is to say, one external collet segment 62 is equivalent in size to two permanent magnets 22. As shown in FIG. 14, gaps between the external collet segments 62 are each positioned between circumferentially neighboring permanent magnets 22 of the rotor core 21. Furthermore, the external collet segments 62 are arranged in such a manner that the gaps between themselves are circumferentially misaligned with respect to the gaps between the external collet segments 52 shown in FIG. 11 by one permanent magnet 22.

Next, the external collet segments 62 are pressed radially inward. Consequently, the open end of the rotor cover 23 is further pushed radially inward by the external collet segments 62. At this time, a portion of the rotor cover 23 that is pushed radially inward may be simply pulled, or may be stretched as in a drawing process, radially inward by the external collet segments 62. Whether the portion is pulled or stretched is adjusted depending on pressing forces of the external collet segments 62. Wrinkles may be or may not be formed in the portion of the rotor cover 23 that is pushed radially inward in pulling or stretching the portion.

The external collet segments 62 exert the pressing forces not only radially inward, but also axially downward. This can reduce springback upon completion of the upper surface portion 26. Axially downward pressing by the external collet segments 62 is attributed to the weight of the external collet segments 62 or application of an external stress, and takes place after the external collet segments 62 have sufficiently moved radially inward.

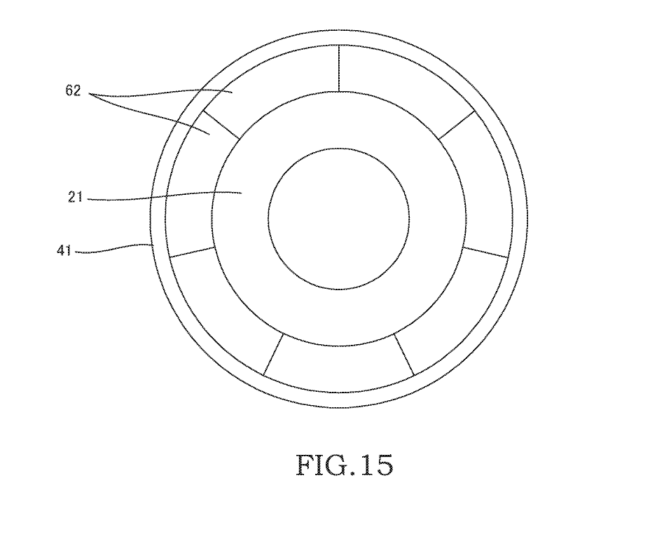

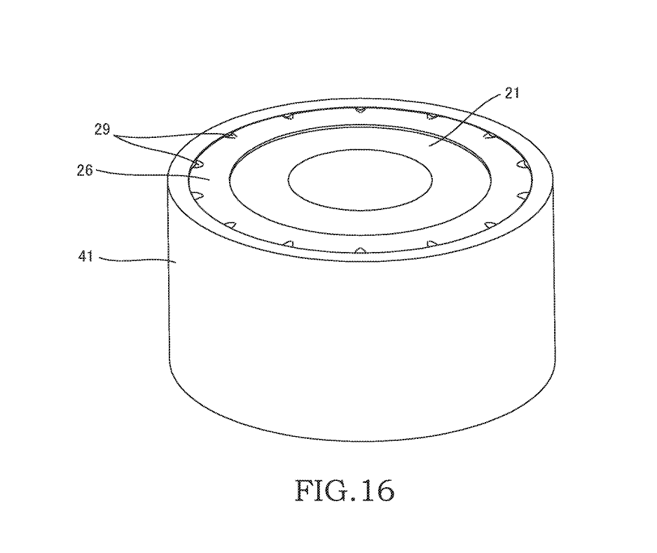

As shown in FIG. 15, the open end of the rotor cover 23 is pushed radially inward so that the gaps between the external collet segments 62 decrease. Consequently, as shown in FIG. 16, removal of the external collet segments 62 reveals that the open end of the rotor cover 23 has been further pushed radially inward relative to the tubular portion 24, and that the upper surface portion 26 has been formed. At this time, in the angular portion 28, portions of the open end of the rotor cover 23 each enter a gap between neighboring permanent magnets 22, thereby forming the groove portions 29.

Next, the external die 41 is removed, and the shaft 1 is inserted into the center of the rotor core 21. As a result, the rotor 2 having the shaft 1 is complete as shown in FIG. 2.

The above embodiment achieves the following effects.

During the formation of the angular portion 28 having a shape of a circular ring in the rotor cover 23, the groove portions 29 are formed as dents between the permanent magnets 22. This can restrict the circumferential rotation of the rotor cover 23. Therefore, an increase in the number of processes can be suppressed in manufacturing the rotor while stopping the rotation of the rotor cover 23.

As the rotor 2 includes one rotor cover 23, the cost of manufacturing the rotor 2 can be reduced.

In the angular portion 28, each groove portion 29 is formed between neighboring permanent magnets 22. When a detent is formed on an inner circumferential surface of the rotor cover in a separate process to stop the rotation with respect to the rotor core, it is necessary to secure a clearance around a portion where the rotor cover and the rotor core are circumferentially locked to each other, in addition to an inner diameter clearance for covering the rotor core with the rotor cover. In this case, it is difficult to set the rotor cover in such a manner that the rotor cover perfectly fits on the rotor core. In contrast, in the present embodiment, the rotor cover 23 is circumferentially pressed, as in a drawing process, to come into close contact with the permanent magnets 22 on the outer circumference of the rotor core. That is to say, the rotor cover 23 is processed in such a manner that it leaves no inner diameter clearance in the vicinity of axial ends of the permanent magnets 22. As a result, the groove portions 29, which are formed in the course of the processes, serve the function of eliminating a clearance, thereby stopping the rotation of the rotor cover 23 more reliably. Furthermore, in the angular portion 28, each groove portion 29 is formed between neighboring permanent magnets 22. Therefore, the angular portion 28 and the upper surface portion 26 enable the rotor cover 23 to fit close to the magnets in the axial direction, thereby preventing an axial displacement of the rotor cover 23.

The inner diameter of the upper surface portion 26 of the rotor cover 23 is smaller than the outer diameter of the rotor core 21. Therefore, in case of breakage of the permanent magnets 22, scattering of broken pieces can be prevented.

In the present embodiment, the open end of the rotor cover 23 is bent radially inward by the external collet segments 42, 52, 62, which press the entire circumference of the open end of the rotor cover 23 radially inward. As a result, the angular portion 28 having a shape of a circular ring is formed, together with the groove portions 29 in the rotor cover 23. Each groove portion 29 represents a dent between circumferentially neighboring permanent magnets 22. That is to say, the rotation of the rotor cover 23 can be stopped simply by placing the rotor core 21 inside the rotor cover 23 and bending the open end of the rotor cover 23 radially inward. As there is no need to perform a new process to stop the rotation of the rotor cover 23, the cost of manufacturing the rotor 2 can be reduced.

In the present embodiment, the open end of the rotor cover 23 is bent radially inward by the external collet segments 42, 52, 62 in the presence of the external die 41 surrounding an outer circumference of the rotor cover 23. In this way, radially outward bulging of the tubular portion 24 of the rotor cover 23 is restricted. It is thus possible to prevent an increase in the outer diameter of the rotor 2 caused by deformation of the rotor cover 23.

In the present embodiment, the open end of the rotor cover 23 is bent radially inward by the external collet segments 42, 52, 62 while the entire inner circumference of the open end of the rotor cover 23 is held by the internal collet segments 43. This can reduce the wrinkles that are formed in the rotor cover 23 when the open end of the rotor cover 23 is bent radially inward.

In the present embodiment, any gap between circumferentially neighboring external collet segments 42, 52, 62 is circumferentially misaligned with respect to any gap between circumferentially neighboring internal collet segments 43. This can prevent the gaps between the external collet segments 42, 52, 62 from facing the gaps between the internal collet segments 43, that is to say, prevent wall portions of the rotor cover 23 from jamming in the gaps between the external collet segments 42, 52, 62 and in the gaps between the internal collet segments 43.

In the present embodiment, the external collet segments 42, 52, 62 are arranged in such a manner that each gap between circumferentially neighboring external collet segments 42, 52, 62 is positioned between circumferentially neighboring permanent magnets 22, and the internal collet segments 43 are arranged in such a manner that each gap between circumferentially neighboring internal collet segments 43 is positioned between circumferentially neighboring permanent magnets 22. In this way, wall portions of the rotor cover 23 escape into the gaps between the permanent magnets 22, and hence the groove portions 29 can be formed between the permanent magnets 22 more reliably.

As shown in FIG. 7B, the height of the external die 41 is substantially the same as the height of the rotor core 21. This enables positioning of the external collet segments 42 in the height direction. As a result, the process of pressing the external collet segments 42 radially inward can be performed in a stable manner. Furthermore, the external collet segments 42, 52, 62 exert the pressing forces not only radially inward, but also axially downward. This can reduce springback of the upper surface portion 26 of the rotor cover 23.

Embodiments of this invention were described above, but the above embodiments are merely examples of applications of this invention, and the technical scope of this invention is not limited to the specific constitutions of the above embodiments.

For example, although each groove portion 29 is formed in the angular portion 28 between neighboring permanent magnets 22 in the above embodiment, a groove portion(s) 29 may be separately formed in the tubular portion 24 of the rotor cover 23 to improve the detent effect. Furthermore, although the above embodiment exemplarily provides the rotor 2 in which the permanent magnets 22 are tightly arranged on the outer circumferential surface of the rotor core 21 having a shape of a circular ring, the present embodiment is also applicable to a rotor in which permanent magnets 22 are arranged between a plurality of protrusions that are formed on the outer circumferential surface of the rotor core 21 throughout the circumferential direction. In this case, each groove portion 29 may be formed between a permanent magnet 22 and a protrusion that neighbor each other, instead of between permanent magnets 22.

In the above embodiment, the upper surface portion 26 of the rotor cover 23 extends radially inward from the angular portion 28 to cover and hide the permanent magnets 22. Alternatively, the upper surface portion 26 may extend to have the permanent magnets 22 partially exposed.

In the above embodiment, the upper surface portion 26 is formed at one end of the rotor cover 23 having a shape of a tube with a bottom. Alternatively, the rotor core 21 may be inserted into a tubular rotor cover 23 that is not provided with the bottom portion 25, and then the upper surface portion 26 may be formed at both ends of the rotor cover 23.

In the above embodiment, in forming the upper surface portion 26 of the rotor cover 23, the external die 41 is placed to surround the entire outer circumference of the tubular portion 24. Alternatively, the external die 41 may be placed to surround a part of the outer circumference of the tubular portion 24, or may not be used.

In the above embodiment, the upper surface portion 26 is gradually formed through three steps that utilize the external collet segments 42, 52, and 62, respectively. Alternatively, the upper surface portion 26 may be formed through one step, or may be gradually formed through two steps or at least four steps. Furthermore, although internal collet segments are not used in reducing the diameter of the open end of the rotor cover 23 with the external collet segments 62 in the above embodiment, internal collet segments similar to the internal collet segments 43, 53 may be used.

Although the upper surface portion 26 is formed using the external collet segments 42, 52, 62 and the internal collet segments 43, 53 in the above embodiment, the upper surface portion 26 may be formed using only the external collet segments 62.

In the above embodiment, any gap between circumferentially neighboring external collet segments 42, 52, 62 is circumferentially misaligned with respect to any gap between circumferentially neighboring internal collet segments 43, 53. Alternatively, the external collet segments 42, 52, 62 and the internal collet segments 43, 53 may be arranged in such a manner that the gaps between the former face the gaps between the latter.

In the above embodiment, the external collet segments 42, 52, 62 are arranged in such a manner that each gap between circumferentially neighboring external collet segments 42, 52, 62 is positioned between circumferentially neighboring permanent magnets 22, and the internal collet segments 43, 53 are arranged in such a manner that each gap between circumferentially neighboring internal collet segments 43, 53 is positioned between circumferentially neighboring permanent magnets 22. Alternatively, each of the gaps between the external collet segments 42, 52, 62 and each of the gaps between the internal collet segments 43, 53 may not be positioned between neighboring permanent magnets 22.

In the above embodiment, the rotor cover 23 is described to be made of non-magnetic stainless steel. Alternatively, the rotor cover 23 may be made of other non-magnetic metals, such as aluminum.

In the above embodiment, the rotation of the rotor cover 23 is stopped by forming, in the angular portion 28 of the rotor cover 23, the groove portions 29 as dents between the permanent magnets 22. Alternatively, after the groove portions 29 have been formed, axial grooves running between the permanent magnets 22 may be formed on the outer circumferential surface of the rotor cover 23. If the outer circumference of the rotor core is simply covered with the rotor cover, the positions between the permanent magnets cannot be checked from the outer side of the rotor cover. This makes it difficult to form the axial grooves running between the permanent magnets 22 in a post-process. On the other hand, in the above embodiment, the groove portions 29 are formed between the permanent magnets 22, even after the rotor cover 23 has been mounted. This makes it possible to check the positions between the permanent magnets, and form the axial grooves running between the permanent magnets 22 in the post-process. Such grooves formed in the post-process further reduce a clearance between the rotor cover 23 and the permanent magnets, thereby stopping the rotation of the rotor cover 23 more reliably.

This application claims priority based on Japanese Patent Application No. 2014-220686 filed with the Japan Patent Office on Oct. 29, 2014, the entire contents of which are incorporated into this specification.

1. A rotor, comprising:
a rotor core fixed to a rotation axis in such a manner that the rotor core is rotatable integrally with the rotation axis, the rotor core having a plurality of permanent magnets mounted thereon throughout a circumferential direction; and
a tubular rotor cover covering an outer circumference of the rotor core,
wherein
the rotor cover includes an angular portion and a groove portion,
the angular portion has a shape of a circular ring and is formed at an axial end of the rotor core, and
the groove portion is formed in the rotor cover, in a course of formation of the angular portion, as a dent between a circumferentially neighboring pair of the plurality of permanent magnets.

2. The rotor according to claim 1,
wherein
the groove portion is formed in the angular portion of the rotor cover, and is positioned between the neighboring pair of the plurality of permanent magnets.

3. The rotor according to claim 1,
wherein
the rotor cover further includes an upper surface portion connected to the angular portion, and
an inner diameter of the upper surface portion is smaller than an outer diameter of the rotor core.

4. A method of manufacturing a rotor including a rotor core fixed to a rotation axis in such a manner that the rotor core is rotatable integrally with the rotation axis, the rotor core having a plurality of permanent magnets mounted thereon throughout a circumferential direction, the method comprising:
covering an outer circumference of the rotor core with a tubular rotor cover; and
forming an angular portion and a groove portion by pressing the rotor cover radially inward using a pressing member for pressing an axial end of the rotor cover radially inward, the angular portion having a shape of a circular ring, and the groove portion being a dent in the rotor cover and being positioned between a circumferentially neighboring pair of the plurality of permanent magnets.

5. The method of manufacturing the rotor according to claim 4,
wherein
in forming the angular portion and the groove portion, the axial end of the rotor cover is pressed radially inward after placing a restricting member for restricting bulging of an outer circumference of the rotor cover.

6. The method of manufacturing the rotor according to claim 4,
wherein
in forming the angular portion and the groove portion, an entire circumference of the axial end of the rotor cover is pressed radially inward while a holding member is placed to hold an entire inner circumference of the axial end of the rotor cover.

7. The method of manufacturing the rotor according to claim 6,
wherein
the pressing member is composed of a plurality of external collet segments circumferentially separated from one another,
the holding member is composed of a plurality of internal collet segments circumferentially separated from one another, and
any gap between a circumferentially neighboring pair of the plurality of external collet segments is circumferentially misaligned with respect to any gap between a circumferentially neighboring pair of the plurality of internal collet segments.

8. The method of manufacturing the rotor according to claim 7,
wherein
the plurality of external collet segments and the plurality of internal collet segments are arranged in such a manner that each gap between a circumferentially neighboring pair of the plurality of external collet segments and each gap between a circumferentially neighboring pair of the plurality of internal collet segments are positioned between a circumferentially neighboring pair of the plurality of permanent magnets.

9. A rotary electric machine, comprising:
the rotor according to claim 1; and
a stator opposing an outer circumference of the rotor via a predetermined void.
